(19) United States
(12) Patent Application Publication
(10) Pub. No.: US 2026/0012264 A1
(43) Pub. Date: Jan. 8, 2026

(54) Communications Circuitry with Injection Locking Stabilization Control

(71) Applicant: Apple Inc., Cupertino, CA (US)

(72) Inventors: Nedim Muharemovic, Nuremberg (DE); Zdravko Boos, Munich (DE); Thomas Mayer, Linz (AT)

(21) Appl. No.: 19/248,040

(22) Filed: Jun. 24, 2025

Related U.S. Application Data
(60) Provisional application No. 63/667,057, filed on Jul. 2, 2024.

(51) Int. Cl. H04B 10/58; H04B 10/50

(52) U.S. Cl. CPC H04B 10/58; H04B 10/503

(57) ABSTRACT

Communication circuitry may be provided with a self-injection locking loop that generates a signal. The loop may include an oscillator, a resonator coupled the oscillator over a first signal path, a square law device, a second signal path that couples a node on the first signal path to the square law device, a phase shifter on the second signal path, and a controller that couples the square law device to the oscillator. A portion of the signal may reflect off the resonator and back towards the oscillator to self-injection lock the oscillator to the resonator. The square law device may generate an electrical signal based on a filtered version of the signal produced by the resonator and a phase-shifted version of the signal produced by the phase shifter. The controller may adjust the oscillator based on the electrical signal to maintain the self-injection locking even as temperature changes over time.

This application claims the benefit of U.S. Provisional Patent Application No. 63/667,057, filed Jul. 2, 2024, which is hereby incorporated by reference herein in its entirety.

### FIELD

This disclosure relates generally to electronic devices, including electronic devices with communications circuitry.

### BACKGROUND

Electronic devices can be provided with communications capabilities. Electronic devices provided with communications capabilities include communications circuitry. The communications circuitry includes clocking circuitry. The clocking circuitry is used to convey signals. The signals can be conveyed wirelessly using an antenna or can be conveyed over a wired path.

As software applications on electronic devices become more data-intensive over time, demand has grown for electronic devices that support communications at higher data rates. However, the maximum data rate supported by the communications circuitry is limited by the frequency of the signals. As communication frequencies increase, it can become difficult to provide low phase noise clocking for the communications circuitry.

### SUMMARY

An electronic device may include communication circuitry. The communication circuitry may include signal generation circuitry. The signal generation circuitry may generate a signal with minimal phase noise and jitter over a range of thermal conditions without use of bulky thermo-electrical coolers. The signal may be an electrical signal such as a radio-frequency signal or may be an optical signal such as an optical local oscillator signal.

The signal generation circuitry may include a self-injection locking loop with an oscillator. A resonator may be coupled to an output of the oscillator over a first signal path. The output of the resonator may be coupled to an input of a square law device. A second signal path may couple a node on the first signal path between the oscillator and the resonator to the input of the square law device. A phase shifter may be disposed on the second signal path. A controller may couple an output of the square law device to an input of the oscillator.

The resonator may output the signal onto the first signal path. A portion of the signal may reflect off the resonator and back towards the oscillator over the first signal path. The reflected portion of the signal may be injected into the oscillator to self-injection lock the oscillator. The square law device may generate an electrical signal based on a filtered version of the signal produced by the resonator and a phase-shifted version of the signal produced by the phase shifter. The controller may adjust the oscillator based on the electrical signal to maintain the self-injection locking of the oscillator to the resonator even as operating temperature changes over time. If desired, first and second self-injection locking loops may provide respective signals to a photomixer. A phase locked loop may be coupled between the photomixer and the optical resonator in the second self-injection locking loop. A frequency locked loop may be coupled between the photomixer and the optical resonator in the first self-injection locking loop.

An aspect of the disclosure provides communication circuitry. The communication circuitry can include an oscillator configured to generate a signal. The communication circuitry can include a resonator having an input coupled to the oscillator over a signal path, the resonator being configured to output a filtered signal based on the signal, and self-injection lock the oscillator by reflecting a portion of the signal back to the oscillator over the signal path. The communication circuitry can include a square law device having an input communicatively coupled to an output of the resonator and configured to generate an electrical signal based on the filtered signal. The communication circuitry can include a controller configured to adjust the oscillator based on the electrical signal.

An aspect of the disclosure provides communication circuitry. The communication circuitry can include a first self-injection locking loop configured to generate a first optical signal using a first laser and a first optical resonator. The communication circuitry can include a second self-injection locking loop configured to generate a second optical signal using a second laser and a second optical resonator. The communication circuitry can include a photomixer configured to generate an electrical signal based on the first optical signal and the second optical signal. The communication circuitry can include a phase locked loop configured to adjust an optical resonance of the second optical resonator based on the electrical signal and a reference clock.

An aspect of the disclosure provides an electronic device. The electronic device can include a laser configured to emit an optical signal. The electronic device can include an optical resonator having a first port coupled to the laser over a first optical path and configured to self-injection lock the laser to a resonant wavelength of the optical resonator using a reflected portion of the optical signal. The electronic device can include an optical combiner having a first input coupled to a node on the first optical path over a second optical path and having a second input coupled to a second port of the optical resonator. The electronic device can include an optical phase shifter disposed on the second optical path. The electronic device can include a photomixer coupled to an output of the optical combiner over a third optical path. The electronic device can include circuitry coupled to an output of the photomixer and configured to adjust a bias of the laser.

### BRIEF DESCRIPTION OF THE DRAWINGS

FIG. 1 is a block diagram of an illustrative electronic device having communications circuitry in accordance with some embodiments.

FIG. 2 is a circuit diagram of illustrative signal generation circuitry in accordance with some embodiments.

FIG. 3 is a diagram of an illustrative optical resonator that may be included in signal generation circuitry in accordance with some embodiments.

FIG. 4 is a circuit diagram of illustrative signal generation circuitry that includes an electro-optical self-injection locking loop in accordance with some embodiments.

FIG. 5 is a circuit diagram of illustrative signal generation circuitry that includes an electro-optical phase locked loop in accordance with some embodiments.

FIG. 6 is a flow chart of illustrative operations that may be performed by an electro-optical phase locked loop to generate signals with minimal phase noise in accordance with some embodiments.

FIG. 7 is a plot showing how illustrative signal generation circuitry of the types shown in FIGS. 2-6 may minimize phase noise in a generated signal in accordance with some embodiments.

FIG. 8 is a circuit diagram of illustrative signal generation circuitry that includes an optical resonator with a through port coupled to a photomixer in accordance with some embodiments.

FIG. 9 is a circuit diagram of illustrative signal generation circuitry that includes a hybrid coupler and a balanced detector in accordance with some embodiments.

### DETAILED DESCRIPTION

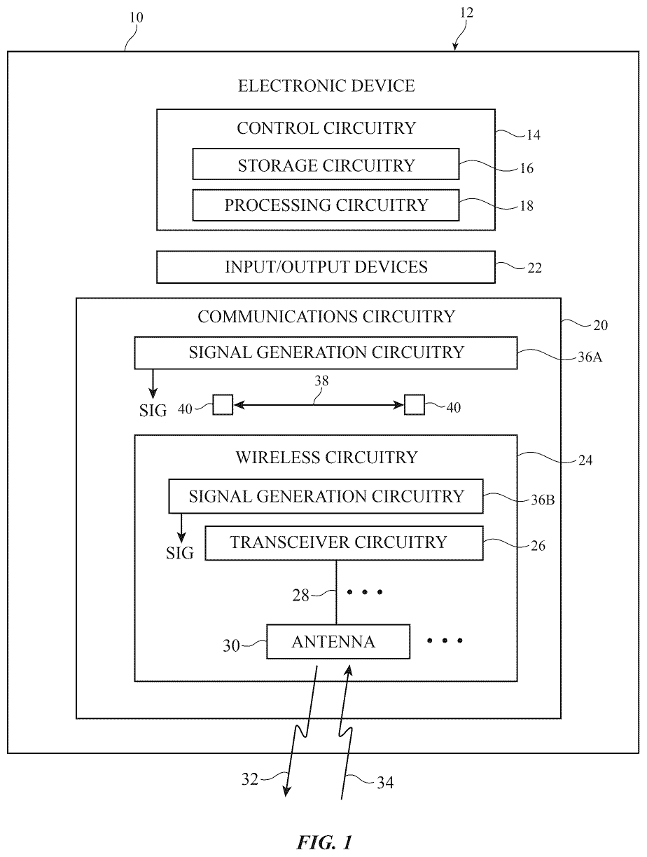

Electronic device 10 of FIG. 1 may be a computing device such as a laptop computer, a desktop computer, a computer monitor containing an embedded computer, a tablet computer, a cellular telephone, a media player, or other handheld or portable electronic device, a smaller device such as a wristwatch device, a pendant device, a headphone or earpiece device, a device embedded in eyeglasses, goggles, or other equipment worn on a user's head (e.g., a virtual, augmented, mixed, or extended reality headset or head-mounted display device), or other wearable or miniature device, a television, a computer display that does not contain an embedded computer, a gaming device, a navigation device, an embedded system such as a system in which electronic equipment with a display is mounted in a kiosk or automobile, a wireless internet-connected voice-controlled speaker, a home entertainment device, a remote control device, a gaming controller, a peripheral user input device, an integrated circuit package, a computer motherboard, a graphics processing chip, a server, a wireless base station or access point, equipment that implements the functionality of two or more of these devices, or other electronic equipment.

As shown in the functional block diagram of FIG. 1, device 10 may include components located on or within an electronic device housing such as housing 12. Housing 12, which may sometimes be referred to as a case, may be formed of plastic, glass, ceramics, fiber composites, metal (e.g., stainless steel, aluminum, metal alloys, etc.), other suitable materials, or a combination of these materials. In some situations, parts or all of housing 12 may be formed from dielectric or other low-conductivity material (e.g., glass, ceramic, plastic, sapphire, etc.). In other situations, housing 12 or at least some of the structures that make up housing 12 may be formed from metal elements.

Device 10 may include control circuitry 14. Control circuitry 14 may include storage such as storage circuitry 16. Storage circuitry 16 may include hard disk drive storage, nonvolatile memory (e.g., flash memory or other electrically-programmable-read-only memory configured to form a solid-state drive), volatile memory (e.g., static or dynamic random-access-memory), etc. Storage circuitry 16 may include storage that is integrated within device 10 and/or removable storage media.

Control circuitry 14 may include processing circuitry such as processing circuitry 18. Processing circuitry 18 may be used to control the operation of device 10. Processing circuitry 18 may include on one or more processors such as microprocessors, microcontrollers, digital signal processors, host processors, baseband processor integrated circuits, application specific integrated circuits, central processing units (CPUs), graphics processing units (GPUs), etc. Control circuitry 14 may be configured to perform operations in device 10 using hardware (e.g., dedicated hardware or circuitry), firmware, and/or software. Software code for performing operations in device 10 may be stored on storage circuitry 16 (e.g., storage circuitry 16 may include non-transitory (tangible) computer readable storage media that stores the software code). The software code may sometimes be referred to as program instructions, software, data, instructions, or code. Software code stored on storage circuitry 16 may be executed by processing circuitry 18.

Control circuitry 14 may be used to run software on device 10 such as satellite navigation applications, internet browsing applications, voice-over-internet-protocol (VOIP) telephone call applications, email applications, media playback applications, operating system functions, etc. To support interactions with external equipment, control circuitry 14 may be used in implementing communications protocols. Communications protocols that may be implemented using control circuitry 14 include internet protocols, wireless local area network (WLAN) protocols (e.g., IEEE 802.11 protocols-sometimes referred to as Wi-Fi®), protocols for other short-range wireless communications links such as the Bluetooth® protocol or other wireless personal area network (WPAN) protocols, IEEE 802.11ad protocols (e.g., ultra-wideband protocols), cellular telephone protocols (e.g., 3G protocols, 4G (LTE) protocols, 3GPP Fifth Generation (5G) New Radio (NR) protocols, Sixth Generation (6G) protocols, sub-THz protocols, THz protocols, etc.), antenna diversity protocols, satellite navigation system protocols (e.g., global positioning system (GPS) protocols, global navigation satellite system (GLONASS) protocols, etc.), antenna-based spatial ranging protocols, optical communications protocols, or any other desired communications protocols. Each communications protocol may be associated with a corresponding radio access technology (RAT) that specifies the physical connection methodology used in implementing the protocol. Control circuitry 14 may also be used in implementing wired communications protocols.

Device 10 may include input-output devices 22. Input-output devices 22 may be used to allow data to be supplied to device 10 and to allow data to be provided from device 10 to external devices. Input-output devices 22 may include user interface devices, data port devices, and other input-output components. For example, input-output devices 22 may include touch sensors, displays (e.g., touch-sensitive and/or force-sensitive displays), light-emitting components such as displays without touch sensor capabilities, buttons (mechanical, capacitive, optical, etc.), scrolling wheels, touch pads, key pads, keyboards, microphones, cameras, buttons, speakers, status indicators, audio jacks and other audio port components, digital data port devices, motion sensors (accelerometers, gyroscopes, and/or compasses that detect motion), capacitance sensors, proximity sensors, magnetic sensors, force sensors (e.g., force sensors coupled to a display to detect pressure applied to the display), temperature sensors, etc. In some configurations, keyboards, headphones, displays, pointing devices such as trackpads, mice, and joysticks, and other input-output devices may be coupled to device 10 using wired or wireless connections (e.g., some of input-output devices 22 may be peripherals that are coupled to a main processing unit or other portion of device 10 via a wired or wireless link).

Device 10 may also include communications circuitry 20 for transmitting, conveying, and/or receiving signals between device 10 and external equipment such as one or more external devices (e.g., other devices such as device 10 or other types of communications equipment). Communications circuitry 20 is sometimes also referred to herein as communication circuitry. If desired, communications circuitry 20 may include wireless circuitry 24 to support wireless communications. Wireless circuitry 24 (sometimes referred to herein as wireless communications circuitry 24) may include one or more antennas 30 (e.g., antenna elements).

Wireless circuitry 24 may also include transceiver circuitry 26. Transceiver circuitry 26 may include transmitter circuitry, receiver circuitry, modulator circuitry, photomixers, demodulator circuitry (e.g., one or more modems), radio-frequency circuitry, one or more radios, intermediate frequency circuitry, optical transmitter circuitry, optical receiver circuitry, optical light sources, other optical components, baseband circuitry (e.g., one or more baseband processors), amplifier circuitry, clocking circuitry such as one or more local oscillators and/or phase-locked loops, memory, one or more registers, filter circuitry, switching circuitry, analog-to-digital converter (ADC) circuitry, digital-to-analog converter (DAC) circuitry, radio-frequency transmission lines, optical fibers, and/or any other circuitry for transmitting and/or receiving wireless signals using antennas 30. The components of transceiver circuitry 26 may be implemented on one integrated circuit, chip, system-on-chip (SOC), die, printed circuit board, substrate, or package, or the components of transceiver circuitry 26 may be distributed across two or more integrated circuits, chips, SOCs, printed circuit boards, substrates, and/or packages.

The example of FIG. 1 is illustrative and non-limiting. While control circuitry 14 is shown separately from communications circuitry 20 in the example of FIG. 1 for the sake of clarity, communications circuitry 20 and/or wireless circuitry 24 may include processing circuitry (e.g., one or more processors) that forms a part of processing circuitry 18 and/or storage circuitry that forms a part of storage circuitry 16 of control circuitry 14 (e.g., portions of control circuitry 14 may be implemented on wireless circuitry 24). As an example, control circuitry 14 may include baseband circuitry (e.g., one or more baseband processors), digital control circuitry, analog control circuitry, and/or other control circuitry that forms part of wireless circuitry 24 and/or communications circuitry 20. The baseband circuitry may, for example, access a communication protocol stack on control circuitry 14 (e.g., storage circuitry 16) to: perform user plane functions at a PHY layer, MAC layer, RLC layer, PDCP layer, SDAP layer, and/or PDU layer, and/or to perform control plane functions at the PHY layer, MAC layer, RLC layer, PDCP layer, RRC, layer, and/or non-access stratum layer.

Transceiver circuitry 26 may be coupled to each antenna 30 in wireless circuitry 24 over a respective signal path 28. Each signal path 28 may include one or more radio-frequency transmission lines, waveguides, optical paths, optical fibers, optical waveguides, and/or any other desired lines/paths for conveying wireless signals between transceiver circuitry 26 and antenna 30. Antennas 30 may be formed using any desired antenna structures for conveying wireless signals. For example, antennas 30 (e.g., antenna elements) may include resonating elements (radiators) that are formed from dipole antenna structures, planar dipole antenna structures (e.g., bowtie antenna structures), slot antenna structures, loop antenna structures, patch antenna structures, inverted-F antenna structures, planar inverted-F antenna structures, helical antenna structures, monopole antennas, dipoles, hybrids of these designs, or any other antenna types. Filter circuitry, switching circuitry, impedance matching circuitry, and/or other antenna tuning components may be adjusted to adjust the frequency response and wireless performance of antennas 30 over time.

If desired, two or more of antennas 30 may be integrated into a phased antenna array (sometimes referred to herein as a phased array antenna) in which each of the antennas conveys wireless signals with a respective phase and magnitude that is adjusted over time so the wireless signals constructively and destructively interfere to produce (form) a signal beam in a given pointing direction. The term “convey wireless signals” as used herein means the transmission and/or reception of the wireless signals (e.g., for performing unidirectional and/or bidirectional wireless communications with external wireless communications equipment). Antennas 30 may transmit the wireless signals by radiating the signals into free space (or to free space through intervening device structures such as a dielectric cover layer). Antennas 30 may additionally or alternatively receive the wireless signals from free space (e.g., through intervening devices structures such as a dielectric cover layer). The transmission and reception of wireless signals by antennas 30 each involve the excitation or resonance of currents on an antenna resonating (radiating) element in the antenna by signals within the frequency band(s) of operation of the antenna.

Transceiver circuitry 26 may use antenna(s) 30 to transmit and/or receive wireless signals that convey wireless communications data between device 10 and external wireless communications equipment (e.g., one or more other devices such as device 10, a wireless access point or base station, etc.). The wireless communications data may be conveyed bidirectionally or unidirectionally. The wireless communications data may, for example, include data that has been encoded into corresponding data symbols, packets, datagrams, and/or frames such as wireless data associated with a telephone call, streaming media content, internet browsing, wireless data associated with software applications running on device 10, email messages, etc.

Additionally or alternatively, wireless circuitry 24 may use antenna(s) 30 to perform wireless sensing operations. The sensing operations may allow device 10 to detect (e.g., sense or identify) the presence, location, orientation, and/or velocity (motion) of objects external to device 10 (e.g., using a radar scheme or another spatial ranging scheme). Control circuitry 14 may use the detected presence, location, orientation, and/or velocity of the external objects to perform any desired device operations. As examples, control circuitry 14 may use the detected presence, location, orientation, and/or velocity of the external objects to identify a corresponding user input for one or more software applications running on device 10 such as a gesture input performed by the user's hand(s) or other body parts or performed by an external stylus, gaming controller, head-mounted device, or other peripheral devices or accessories, to determine when one or more antennas 30 needs to be disabled or provided with a reduced maximum transmit power level (e.g., for satisfying regulatory limits on radio-frequency exposure), to determine how to steer (form) a radio-frequency signal beam produced by antennas 30 for wireless circuitry 24 (e.g., in scenarios where antennas 30 include a phased array of antennas 30), to map or model the environment around device 10 (e.g., to produce a software model of the room where device 10 is located for use by an augmented reality application, gaming application, map application, home design application, engineering application, etc.), to detect the presence of obstacles in the vicinity of (e.g., around) device 10 or in the direction of motion of the user of device 10, etc.

Wireless circuitry 24 may transmit and/or receive wireless signals within corresponding frequency bands of the electromagnetic spectrum (sometimes referred to herein as communications bands or simply as “bands”). The frequency bands handled by wireless circuitry 24 may include wireless local area network (WLAN) frequency bands (e.g., Wi-Fi® (IEEE 802.11) or other WLAN communications bands) such as a 2.4 GHz WLAN band (e.g., from 2400 to 2480 MHZ), a 5 GHz WLAN band (e.g., from 5180 to 5825 MHZ), a Wi-Fi® 6E band (e.g., from 5925-7125 MHZ), and/or other Wi-Fi® bands (e.g., from 1875-5160 MHZ), wireless personal area network (WPAN) frequency bands such as the 2.4 GHz Bluetooth® band or other WPAN communications bands, cellular telephone frequency bands (e.g., bands from about 600 MHz to about 5 GHz, 3G bands, 4G LTE bands, 5G New Radio Frequency Range 1 (FR1) bands below 10 GHz, 5G New Radio Frequency Range 2 (FR2) bands between 20 and 60 GHz, etc.), other centimeter or millimeter wave frequency bands (e.g., between 10-300 GHZ), near-field communications frequency bands (e.g., at 13.56 MHZ), satellite navigation frequency bands (e.g., a GPS band from 1565 to 1610 MHz, a Global Navigation Satellite System (GLONASS) band, a BeiDou Navigation Satellite System (BDS) band, etc.), ultra-wideband (UWB) frequency bands that operate under the IEEE 802.15.4 protocol and/or other ultra-wideband communications protocols, communications bands under the family of 3GPP wireless communications standards, communications bands under the IEEE 802.XX family of standards, and/or any other desired frequency bands of interest.

Over time, software applications on electronic devices such as device 10 have become more and more data intensive. Communications circuitry on the electronic devices therefore needs to support data transfer at higher and higher data rates. In general, the data rates supported by the communications circuitry are proportional to the frequency of the signals conveyed by the communications circuitry (e.g., higher frequencies can support higher data rates than lower frequencies). Communications circuitry 20 may convey centimeter and millimeter wave signals to support relatively high data rates (e.g., because centimeter and millimeter wave signals are at relatively high frequencies between around 10 GHz and 300 GHz). However, the data rates supported by centimeter and millimeter wave signals may still be insufficient to meet all the data transfer needs of device 10. To support even higher data rates such as data rates up to 5-10 Gbps or higher, communications circuitry 20 may convey wireless signals at frequencies greater than 100 GHz.

As shown in FIG. 1, wireless circuitry 24 may transmit wireless signals 32 and may receive wireless signals 34. Wireless signals 32 and 34 may be conveyed at frequencies greater than around 100 GHz if desired (sometimes also referred to as tremendously high frequency (THF) frequencies). When conveyed at frequencies greater than about 100 GHz, wireless signals 32 and 34 are sometimes also referred to herein as THF signals, sub-THz signals, THz signals, or sub-millimeter wave signals. THF signals conveyed by wireless circuitry 24 may be at sub-THz or THz frequencies such as frequencies between about 100 GHz and about 1 THz, between about 100 GHz and about 10 THz, between 100 GHz and 2 THz, between 200 GHz and 1 THz, between 300 GHz and 1 THz, between 300 GHz and 2 THz, between 300 GHz and 10 THz, between 100 GHz and 800 GHz, between 200 GHz and 1.5 THz, etc. (e.g., within a sub-THz, THz, THF, or sub-millimeter frequency band such as a 3GPP Sixth Generation (6G) frequency band).

The high data rates supported by these frequencies may be leveraged by device 10 to perform cellular telephone voice and/or data communications (e.g., while supporting spatial multiplexing to provide further data bandwidth), to perform spatial ranging operations such as radar operations to detect the presence, location, and/or velocity of objects external to device 10, to perform automotive sensing (e.g., with enhanced security), to perform health/body monitoring on a user of device 10 or another person, to perform gas or chemical detection, to form a high data rate wireless connection between device 10 and another device or peripheral device (e.g., to form a high data rate connection between a display driver on device 10 and a display that displays ultra-high resolution video), to form a remote radio head (e.g., a flexible high data rate connection), to form a THF chip-to-chip connection within device 10 that supports high data rates (e.g., where one antenna 30 on a first chip in device 10 transmits wireless signals 32 to another antenna 30 on a second chip in device 10), and/or to perform any other desired high data rate operations. Wireless circuitry 24 may include one or more antennas 30 that convey THF signals (e.g., at frequencies greater than around 100 GHz) and/or may include one or more antennas 30 that convey non-THF signals (e.g., at frequencies less than around 100 GHZ). These examples are illustrative and, if desired, wireless circuitry 24 may convey wireless signals 32 and 34 in other frequency bands.

Communications circuitry 20 may include signal generation circuitry 36. Signal generation circuitry 36 may generate and output a signal (SIG) at relatively high frequencies. Signal SIG may be, for example, a radio-frequency signal at frequencies between around 600 MHz and around 10 THz or may be an optical signal at optical frequencies (e.g., visible frequencies, infrared or near infrared frequencies, ultraviolet frequencies, etc.). Communications circuitry 20 may use signal SIG to convey wireless data (or other signals that do not carry wireless data) with an external device. The high frequency of signal SIG may serve to maximize the data rate with which communications circuitry 20 conveys wireless data with the external device.

Signal generation circuitry 36 may, for example, include digital and/or analog clocking circuitry that generates signal SIG. Communications circuitry 20 may use signal SIG to clock signal transmission and/or reception by device 10 (e.g., signal SIG may be a clocking signal such as an electrical or optical local oscillator signal). The clocking circuitry may include one or more oscillators (e.g., reference oscillators, crystal oscillators, voltage controlled oscillators, etc.), phase locked loops (PLLs), frequency locked loops (FLLs), self-injection-locking loops, and/or other clocking circuitry that generates signal SIG. Signal generation circuitry 36 is sometimes also referred to herein as clocking circuitry 36 or signal generator 36.

If desired, communications circuitry 20 may use signal SIG to upconvert and/or downconvert an additional signal between different frequencies (e.g., by providing signal SIG and the additional signal to mixer circuitry that upconverts or downconverts the additional signal to a desired frequency by mixing the additional signal with signal SIG). The additional signal may carry data (e.g., a stream of data bits organized into a corresponding data structure such as a packet, frame, symbol, datagram, etc.).

As another example, communications circuitry 20 may modulate data onto signal SIG itself and the modulated signal may be transmitted to an external device and/or may be used to generate other signals that are transmitted to an external device. As another example, communications circuitry 20 may receive a signal that carries modulated data and may use signal SIG to convert, demodulate, mix, and/or otherwise process the received signal carrying the modulated data. In general, signal SIG may be any desired signal that is transmitted by communications circuitry 20 to an external device, that is used by communications circuitry 20 to transmit other signals to an external device, that is used by communications circuitry 20 to receive other signals from an external device, that is transmitted between components 40 in device 10, that is used to transmit another signal between components 40 in device 10, or that is used to receive another signal between components 40 in device 10. One or more of components 40 may be formed within wireless circuitry 24, within transceiver circuitry 26, within input/output devices 22, or within control circuitry 14 if desired.

Signal generation circuitry 36 may include electro-optical (EO) signal generation circuitry or may include electrical signal generation circuitry. EO signal generation circuitry (e.g., EO clocking circuitry) in signal generation circuitry 36 may generate signal SIG in the optical domain (e.g., signal SIG may be an optical signal such as an optical local oscillator signal) or in the electrical domain (e.g., signal SIG may be an electrical signal such as a radio-frequency signal). The EO signal generation circuitry may include one or more electro-optical phase locked loops (EOPLLs), EO FLLs, and/or EO self-injection-locking loops if desired. Electrical signal generation circuitry in signal generation circuitry 36 may generate signal SIG in the electrical domain (e.g., at radio frequencies).

If desired, signal generation circuitry 36 may include signal generation circuitry 36B in wireless circuitry 24. Wireless circuitry 24 may use signal generation circuitry 36B to transmit wireless signals 32 and/or to receive wireless signals 34 using transceiver circuitry 26 and antenna(s) 30. Signal generation circuitry 36B may be included within transceiver circuitry 26 or may be external to transceiver circuitry 36B. Signal generation circuitry 36B may provide signal SIG to one or more mixers, photomixers (e.g., photodiodes), and/or other circuitry in transceiver circuitry 26, for example.

If desired, signal generation circuitry 36 may include signal generation circuitry 36A in communications circuitry 20 but external to wireless circuitry 24. Communications circuitry 20 may use signal generation circuitry 36A to convey electrical or optical signals over a signal path 38 between components 40 in communications circuitry 20. Signal path 38 may be a wired signal path (e.g., a radio-frequency transmission line path that conveys electrical signals or an optical path that conveys optical signals). Components 40 may be any desired components in communications circuitry 20 and/or device 10.

As one example, a first component 40 may generate a signal that includes or that is based on (e.g., clocked using) the signal SIG generated by signal generation circuitry 36A and may transmit the generated signal to a second component 40 over signal path 38. The second component 40 may be, for example, an electrical connector (e.g., a radio-frequency connector) that is coupled to an external device over an external electrical signal path (e.g., a cable or radio-frequency transmission line). The electrical connector may transmit the signal from signal path 38 to the external device over the external signal path. Alternatively, the second component 40 may be an optical connector that is coupled to the external device over an external optical signal path (e.g., an optical fiber or waveguide). The optical connector may transmit the signal from signal path 38 to the external device over the external signal path.

Conversely, the second component 40 may be an electrical connector that receives an electrical signal from the external device over an external electrical signal path or may be an optical connector that receives an optical signal from the external device over an external optical signal path. The second component 40 may transmit the electrical or optical signal to the first component 40 over signal path 38. The first component 40 may receive and process (e.g., downconvert, upconvert, mix, etc.) the electrical or optical signal using the signal SIG generated by signal generation circuitry 36A. If desired, wireless circuitry 24 may be omitted from device 10 (e.g., device 10 need not convey wireless signals).

If desired, one or more mixers in communications circuitry 20 may receive signal SIG for converting other signals between different frequencies (e.g., between baseband frequencies, intermediate frequencies, radio frequencies, optical frequencies, etc.). The mixers may include one or more radio mixers (e.g., for converting between radio, intermediate, and/or baseband frequencies) and/or one or more electro-optical (EO) mixers (e.g., for converting between radio frequencies and optical frequencies or between optical frequencies). The EO mixers may sometimes be referred to herein as photomixers and may include photodiodes (e.g., uni-travelling-carrier photodiodes (UTC PDs) or other types of programmable photodiodes), electrooptical modulators (e.g., Mach-Zehnder modulators), and/or other mixers that convert signals from radio frequencies to optical frequencies and/or from optical frequencies to radio frequencies.

When signal SIG is used to convey wired and/or wireless signals at relatively high frequencies (e.g., radio frequencies greater than around 10-100 GHz, optical frequencies, etc.), if care is not taken, signal SIG can exhibit excessive phase noise and/or jitter. Excessive phase noise and jitter can undesirably deteriorate the wired and/or wireless signals conveyed between device 10 and the external device. Phase noise and jitter is also particularly sensitive to temperature. Variations in temperature can produce different amounts of phase noise and jitter. Additional devices such as thermo-electrical coolers (e.g., Peltier elements) can be used to help control the temperature of communications circuitry 20 and thus phase noise and jitter, but can be excessively bulky, expensive, and power hungry.

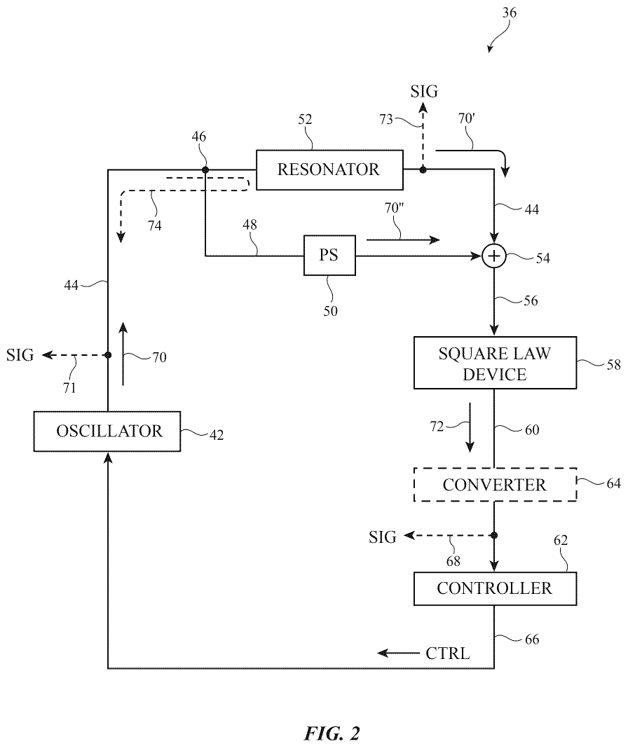

To help mitigate these issues, signal generation circuitry 36 may include a self-injection locking loop and a resonator that effectively mitigate phase noise and jitter across operating temperatures (e.g., without requiring additional bulky temperature control devices such as thermo-electrical coolers). FIG. 2 is a circuit diagram of signal generation circuitry 36 in implementations where signal generation circuitry 36 includes a self-injection locking loop and a resonator that effectively mitigate phase noise and jitter across operating temperatures.

As shown in FIG. 2, signal generation circuitry 36 (e.g., signal generation circuitry 36A or 36B of FIG. 1) may include components such as oscillator 42, resonator 52, phase shifter (PS) 50, signal combiner 54, square law device 58, and controller 62. The output of oscillator 42 may be coupled to a first input of signal combiner 54 over signal path 44. Resonator 52 may be disposed on signal path 44. The input of resonator 52 may be communicatively coupled to the output of oscillator 42. The output of resonator 52 may be communicatively coupled to the first input of signal combiner 43.

Signal path 48 may couple node 46 on signal path 44 to a second input of signal combiner 54. Phase shifter 50 may be disposed on signal path 48. Phase shifter 50 may be a fixed phase shifter that applies a fixed phase shift (e.g., 180 degrees or other phase shifts) to a signal at its input. Alternatively, phase shifter 50 may be an adjustable phase shifter that receives a control signal that sets the amount of phase shift applied by phase shifter 50 to the signal at its input.

Node 46 may include a signal coupler or a signal splitter, as two examples. Node 46 may be interposed between the output of oscillator 42 and the input of resonator 52 on signal path 44. The output of signal combiner 54 may be coupled to the input of square law device 58 over signal path 56. The output of square law device 58 may be coupled to the input of controller 62 over signal path 60. If desired, an optional signal converter 64 (e.g., an optical to electrical converter) may be disposed on signal path 60 between square law device 58 and controller 62. Controller 62 may have an output coupled to an input of oscillator 42 (e.g., a control terminal or bias terminal of oscillator 42) over control path 66.

Signal generation circuitry 36 may form a self-injection-locking loop around oscillator 42 (e.g., over signal path 44, through resonator 52 and phase shifter 50, through signal combiner 54, over signal path 56, through square law device 58, over signal path 60, through controller 62, and over control path 66). Signal generation circuitry 36 of FIG. 2 may include electrical signal generation circuitry or may include electro-optical signal generation circuitry.

In implementations where signal generation circuitry 36 includes electro-optical signal generation circuitry, signal paths 44, 48, and 56 may be optical paths (e.g., optical fibers and/or waveguides) and signal path 66 may be an electrical path. Converter 64 may convert optical signals output by square law device 58 onto signal path 60 into electrical signals provided to controller 62. Oscillator 42 may be a light source such as a laser. The laser may be adjusted based on a control signal CTRL (e.g., a tunable bias voltage) received from controller 62 over control path 66. Square law device 58 and converter 64 may be implemented using a photomixer such as a photodiode (PD) or another electro-optical heterodyne or homodyne device. While referred to herein as a square law device for the sake of simplicity, square law device 58 need not be a perfect or ideal square law device and may also exhibit one or more higher order linearities that are not exhibited by a perfect or ideal square law device (e.g., square law device 58 may be a photomixer or photodiode with higher order non-linearities compared to an ideal square law device). Phase shifter 50 may be an optical phase shifter. Signal combiner 54 may be an optical combiner, adder, or coupler. Resonator 52 may be an optical resonator.

In implementations where signal generation circuitry 36 includes electrical signal generation circuitry, signal paths 44, 48, 56, 60, and 66 may be electrical paths. Converter 64 may be omitted. Oscillator 42 may be an electrical oscillator such as a crystal oscillator, a voltage controlled oscillator, etc. The frequency of oscillator 42 may be adjusted based on a control signal CTRL (e.g., a tunable voltage) received from controller 62 over control path 66. Square law device 58 may be any desired electrical device (e.g., a heterodyning or homodyning electrical device) that outputs a signal by applying a square law (squaring) function to the signal at its input. While referred to herein as a square law device for the sake of simplicity, square law device 58 need not be a perfect square law device and may also exhibit one or more higher order linearities that are not exhibited by a perfect square law device. Square law device 58 may include an electrical homodyne device, an electrical heterodyne device, an electrical counter, an electrical mixing device, etc. Alternatively, square law device 58 may be replaced with an electrical counter. Phase shifter 50 may be an electrical phase shifter. Signal combiner 54 may be an electrical combiner, adder, or coupler. Resonator 52 may be an electrical resonator (e.g., a cavity resonator, a transmission line resonator, an antenna resonator, a resonant circuit such as a tank circuit, etc.).

Signal generation circuitry 36 may use its self-injection-locking loop to generate signal SIG with minimal phase noise and jitter. Signal generation circuitry 36 may output signal SIG (e.g., as an electrical or optical signal) over an output terminal (port) 71 coupled to signal path 44 between resonator 52 and oscillator 42, may output signal SIG (e.g., as an electrical or optical signal) over an output terminal 73 coupled to signal path 44 between resonator 52 and signal combiner 54, may output signal SIG (e.g., as an electrical signal) over an output terminal 68 coupled to signal path 60, or may output signal SIG at any other desired location (e.g., an output terminal coupled to signal path 48, an output terminal coupled to signal path 56, etc.).

While generating signal SIG, oscillator 42 may generate signal 70 (e.g., an electrical or optical signal) on signal path 44. Signal path 44 may pass signal 70 to resonator 52. Some of signal 70 may also be coupled off of signal path 44 and onto signal path 48 at node 46. Signal 70 may resonate within resonator 52. The resonance of resonator 52 may serve as a frequency discriminator or filter that passes a filtered signal 70′ (e.g., a filtered version of signal 70) to signal combiner 54. Filtered signal 70′ may, for example, be at the resonant frequency of resonator 52 (e.g., resonator 52 may filter out other frequencies of signal 70). Some of the signal 70 incident upon the input of resonator 52 may reflect off of resonator 52 and back towards the output of oscillator 42, as shown by arrow 74. This reflected signal may be injected into oscillator 42 and may serve to injection lock oscillator 42 to the resonance of resonator 52. At the same time, phase shifter 50 may apply a phase shift (e.g., a 180 degree phase shift or another phase shift) to the signal 70 on signal path 48, producing a phase shifted signal 70″ that propagates to signal combiner 54.

Signal combiner 54 may combine filtered signal 70′ with phase shifted signal 70″ to produce a combined signal that is passed to square law device 58. Square law device 58 may apply a squaring function to the combined signal to produce a signal 72 on signal path 60. If desired, converter 64 may convert signal 72 between electrical and optical domains. Controller 62 may receive signal 72 over signal path 60. Controller 62 may generate control signal CTRL based on signal 72. Control signal CTRL may, for example, be an error signal that characterizes the phase and/or magnitude error (difference) between the signals on signal paths 44 and 48. Control signal CTRL may adjust oscillator 42 (e.g., may control oscillator 42 to adjust the phase and/or frequency of its generated signal 70) in a manner that reduces the error while oscillator 42 remains self-injection locked to resonator 52. By iterating over the self-injection-locking loop a sufficient number of times in this way, the error can be minimized and oscillator 42 may self-injection-lock signal 70 in a manner that minimizes its phase noise and jitter. This may cause the corresponding signal SIG output by signal generation circuitry 36 to exhibit minimal phase noise and jitter.

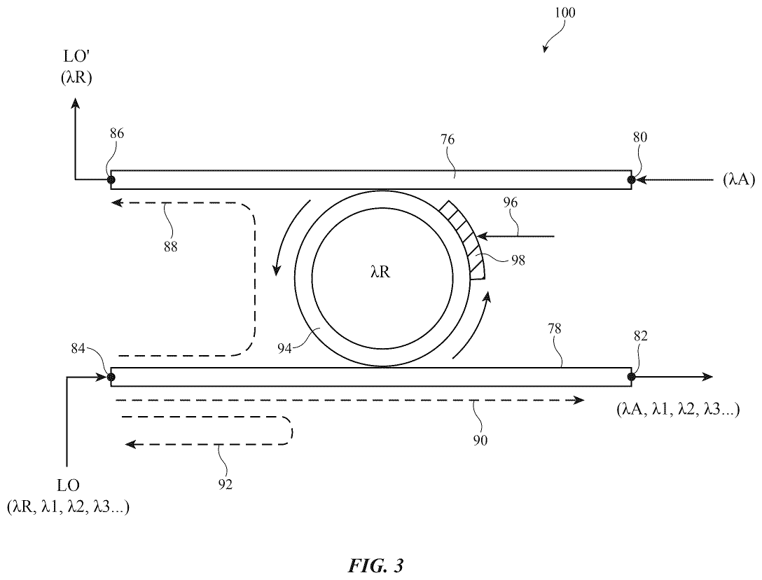

In general, signal generation circuitry 36 may include electrical signal generation circuitry or electro-optical signal generation circuitry. In implementations where signal generation circuitry 36 includes electro-optical signal generation circuitry, resonator 52 may include an optical resonator. FIG. 3 is a diagram of an optical resonator 100 that may be used to implement resonator 52 of signal generation circuitry 36 in implementations where signal generation circuitry 36 includes electro-optical signal generation circuitry.

Optical resonator 100 may be, for example, an optical micro-resonator (MR) that contains a resonant optical loop such as optical loop 94 (e.g., a loop or ring of optical fiber or waveguide). As shown in FIG. 3, optical resonator 100 may also include a first optical path 76 (e.g., a first optical fiber or waveguide) and a second optical path 78 (e.g., a second optical fiber or waveguide). Optical loop 94 may be physically interposed between optical paths 76 and 78. Optical loop 94 may optically couple optical path 78 to optical path 76 (e.g., optical loop 94 may be optically coupled between optical paths 76 and 78).

Optical resonator 100 may have a first port 84 coupled to a first end of optical path 78, a second port 82 coupled to a second end of optical path 78, a third port 86 couple to a first end of optical path 76, and a fourth port 80 coupled to a second end of optical path 76. Optical resonator 100 may receive optical signals at port 84 and/or port 80 and may output optical signals at port 86 and/or port 82. Port 86 is sometimes also referred to as the drop port 86 of optical resonator 100. Port 80 is sometimes also referred to as the add port of optical resonator 100. Port 84 is sometimes also referred to as the input port of optical resonator 100. Port 82 is sometimes also referred to as the through port of optical resonator 100.

During operation, optical loop 94 may carry an optical signal in a set of optical resonances each at a corresponding optical resonant wavelength. The set of optical resonances is sometimes also referred to as an optical comb, a wavelength comb, or a frequency comb. The dimensions of optical loop 94 (e.g., the radius or diameter of optical loop 94) may establish the particular optical resonances (resonant wavelengths) of the optical comb for the optical resonator.

An optical signal such as optical local oscillator signal LO may be incident upon input port 84 of optical resonator 100. Optical local oscillator signal LO may contain a set of many different wavelengths of light (e.g., wavelengths λR, λ1, λ2, λ3, . . . ). As shown by arrow 88, the wavelength of optical local oscillator signal LO matching a resonant wavelength λR of optical loop 94 may be coupled off of optical path 78 and onto optical loop 94, may resonate around optical loop 94, and may be coupled off of optical loop 94 and onto optical path 76, which propagates the wavelength λR of optical local oscillator signal LO to drop port 86. Optical resonator 100 may output the resonant wavelength λR of optical local oscillator signal LO at drop port 86 (as filtered optical local oscillator signal LO′ at wavelength λR).

If desired, optical resonator 100 may receive an additional optical signal at wavelength 2A via add port 80. The removal of wavelength λR from optical local oscillator signal LO causes the remaining wavelengths of optical local oscillator signal LO (e.g., wavelengths λ1, λ2, λ3, . . . ) to propagate along signal path 78 to through port 82 (as shown by arrow 90). If desired, optical resonator 100 may output the remaining wavelengths of optical local oscillator signal LO (e.g., wavelengths λ1, λ2, λ3, . . . ) and the wavelength λA received at add port 80 via through port 82. Alternatively, add port 80 and/or optical port 82 may be open or floating if desired. In this way, optical resonator 100 may serve as an optical filter for optical local oscillator signal LO between input port 84 and drop port 86, filtering out the wavelengths of optical local oscillator signal LO other than the resonant wavelength λR of optical loop 94 from the optical local oscillator signal to produce filtered optical local oscillator signal LO′ of wavelength λR (at drop port 86).

At the same time, at least some of the optical local oscillator signal LO received at input port 84 may be reflected by optical loop 94 back towards input port 84, as shown by arrow 92. For example, the at least some of the wavelength(s) of optical local oscillator signal LO matching the wavelengths of the optical resonance(s) of optical loop 94 may be reflected back towards input port 84 as a reflected optical local oscillator signal. Optical resonator 100 may output this reflected optical local oscillator signal at input port 84. If desired, the reflected optical local oscillator signal may be injected into the laser that emitted optical local oscillator signal LO (e.g., oscillator 42 of FIG. 2 may include a laser and the reflected optical local oscillator signal may be injected into the laser to injection lock the laser to an optical resonance of the optical resonator). The laser may, for example, be locked to the resonant wavelength λR of optical resonator 100. In this way, optical resonator 100 may serve to both injection lock the laser and filter the optical local oscillator signal.

If desired, optical resonator 100 may include a mechanical actuator such as actuator 98. Actuator 98 may receive an electrical signal such as control signal 96 (e.g., a voltage or current signal). Control signal 96 may cause actuator 98 to mechanically adjust the physical dimensions of optical loop 94 (e.g., diameter, radius, width, length, etc.). This adjustment may change the resonant wavelengths of the optical resonances in the optical comb of optical loop 94. Actuator 98 may include an electromechanical actuator such as a piezoelectric actuator, a microelectromechanical systems (MEMS) actuator, thermal circuitry, a PN junction, or another type of actuator.

In electrical implementations of signal generation circuitry 36, optical resonator 100 is replaced with an electrical (e.g., radio-frequency) resonator in resonator 52 of FIG. 2, optical local oscillator signal LO is replaced by an electric signal generated by an electrical oscillator (e.g., in oscillator 42 of FIG. 2), the electrical resonator may pass wavelengths (frequencies) of the electrical signal matching a resonant wavelength (frequency) of the electrical resonator, the electrical resonator may reflect some of the electrical signal matching the resonant wavelength (frequency) back towards the electrical oscillator, and the reflected electrical signal may be injected into the electrical oscillator to injection lock the electrical oscillator to the resonance of the electrical resonator. In this way, the electrical resonator may serve as an electrical filter for the electrical signal while also serving to injection lock the electrical oscillator.

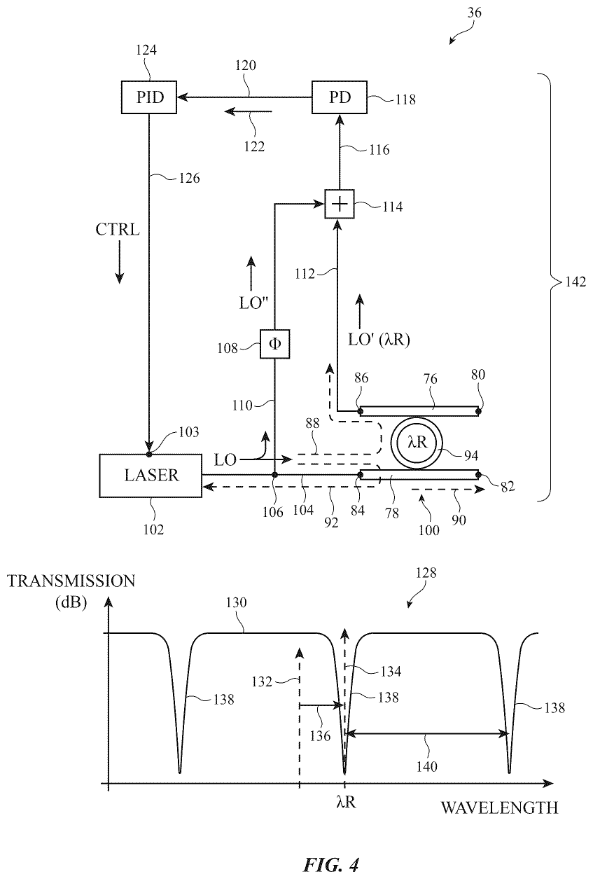

FIG. 4 is a circuit diagram of signal generation circuitry 36 in implementations where signal generation circuitry 36 includes electro-optical signal generation circuitry and optical resonator 100. As shown in FIG. 4, signal generation circuitry 36 may include an electro-optical self-injection locking loop such as self-injection locking loop 142 (sometimes also referred to herein as self-injection locking loop circuitry 142, self-injection locking loop circuit 142, self-injection locked loop 142, electro-optical self-injection locking loop 142, or electro-optical self-injection locked loop 142). Self-injection locking loop 142 may include an optical oscillator such as laser 102, optical resonator 100, an optical phase shifter such as optical phase shifter 108, an optical signal combiner such as optical signal combiner 114, a photomixer such as photomixer 118, and a laser controller such as proportional integral derivative (PID) controller 124.

Laser 102 may, for example, form oscillator 42 of FIG. 2. The output of laser 102 may be coupled to input port 84 of optical resonator 100 over optical path 104. Optical resonator 100 may, for example, form resonator 52 of FIG. 2. Drop port 86 of optical resonator 100 may be coupled to a first input of optical signal combiner 114 over optical path 112. Optical paths 112 and 104 may, for example, collectively form signal path 44 of FIG. 2. Optical signal combiner 114 may include, for example, an optical coupler or optical adder.

Optical path 78 of optical resonator 100 may be formed from an integral part of optical path 104 or may, if desired, be optically coupled to optical path 104 at input node 84 (e.g., by an optical coupler, prism, lens, etc.). Optical path 76 of optical resonator 100 may be formed from an integral part of optical path 104 or may, if desired, be optically coupled to optical path 112 (e.g., by an optical coupler, prism, lens, etc.). Through port 82 of optical resonator 100 may be coupled to an additional optical path (e.g., an optical output path of self-injection locking loop 142) or may be open/floating. Add port 82 of optical resonator 100 may be coupled to an additional optical path (e.g., an optical add path) or may be open/floating.

An optical path such as optical path 110 may be coupled between node 106 on optical path 104 and a second input of optical signal combiner 114. Node 106 may include an optical coupler or an optical signal splitter and may, for example, form node 46 of FIG. 2. Optical path 110 may, for example, form signal path 48 of FIG. 2. Optical signal combiner 114 may, for example, form signal combiner 54 of FIG. 2.

An optical path such as optical path 116 may optically couple the output of optical signal combiner 114 to photomixer 118 (e.g., optical path 116 may optically illuminate a photoactive area of photomixer 118 using optical signals on optical path 116). Optical path 116 may, for example, form signal path 56 of FIG. 2. If desired, one or more additional optical components (not shown) such as an optical coupler, prism, or lens may be used to direct optical signals from optical path 116 onto the photoactive area of photomixer 118.

Photomixer 118 may have an electrical output coupled to an input of PID controller 124 over electrical path 120. Photomixer 118 may include a photodiode (PD) or another electro-optical heterodyning and/or square law device. Photomixer 118 may apply a squaring function to optical signals received over optical path 116 and may convert the optical signals received over optical path 116 into electrical signals 122 on electrical path 120. Photomixer 118 may, for example, form square law device 58 and converter 64 of FIG. 2. Electrical path 120 may, for example, form signal path 60 of FIG. 2.

PID controller 124 may have an output coupled to an input 103 of laser 102 over electrical path 126. PID controller 124 may, for example, form controller 62 of FIG. 2. PID controller 124 may include, for example, an operational amplifier, a comparator, a filter, and/or other components. Electrical path 126 may, for example, form control path 66 of FIG. 2. Input 103 may be a control input or a biasing input (terminal) of laser 102. Optical paths 104, 110, 112, and 116 may be formed from optical fiber or optical waveguides that convey (propagate) optical signals. Electrical paths 120 and 126 may include conductive signal lines and/or a radio-frequency transmission lines that convey (propagate) electrical signals (e.g., radio-frequency signals). Electrical paths are sometimes also referred to herein as electrical signal paths. Optical paths are sometimes also referred to herein as optical signal paths.

During signal generation, laser 102 may generate (emit) optical local oscillator signal LO (e.g., signal 70 of FIG. 2) on optical path 104. Self-injection locking loop 142 may output one or more wavelengths of optical local oscillator signal LO (e.g., as signal SIG of FIG. 2) at an output terminal, path, or port (not shown) coupled to optical path 112, optical path 116, optical path 110, through port 82, or elsewhere. Alternatively, self-injection locking loop 36 may output an electrical signal (e.g., as signal SIG of FIG. 2) generated using optical local oscillator signal LO at an output terminal, path, or port (not shown) coupled to electrical path 120.

Optical path 104 may propagate optical local oscillator signal LO to input port 84 of optical resonator 100. Node 106 may couple some of optical local oscillator signal LO off of optical path 104 and onto optical path 110. Optical path 110 may propagate optical local oscillator signal LO to optical phase shifter 108. Optical phase shifter 108 may apply an optical phase shift ϕ to optical local oscillator signal LO to produce phase-shifted optical local oscillator signal LO″. Phase-shifted optical local oscillator signal LO″ may, for example, form phase shifted signal 70″ of FIG. 2.

Phase shift ϕ may be 180 degrees or another phase shift (e.g., phase-shifted optical local oscillator signal LO″ may be 180 degrees out of phase with respect to optical local oscillator signal LO as provided to input port 84 of optical resonator 100 or may be phase-shifted with respect to the optical local oscillator signal LO provided to input port 84 by another amount). Phase shift ϕ may be fixed or may be adjustable (e.g., optical phase shifter 108 may receive an electrical control signal (not shown) that sets and/or adjusts phase shift ϕ over time). Optical path 110 may propagate phase-shifted optical local oscillator signal LO″ to the second input of optical signal combiner 114 over optical path 110.

At the same time, as shown by arrow 88, optical resonator 100 may pass wavelength λR of optical local oscillator signal LO from input port 84 onto drop port 86 as filtered optical local oscillator signal LO′ (e.g., via a corresponding optical resonance λR of optical loop 94). Filtered optical local oscillator signal LO′ is at wavelength λR. Filtered optical local oscillator signal LO′ may, for example, form filtered signal 70′ of FIG. 2. Optical resonator 100 may pass the other wavelengths filtered from the optical local oscillator signal LO at input port 84 onto through port 82, as shown by arrow 90. Optical path 112 may propagate filtered optical local oscillator signal LO′ from drop port 86 to the first input of optical signal combiner 114. The phase shift ϕ imparted by optical phase shifter 108 may, if desired, correspond to an amount of phase shift (phase delay) imparted by optical resonator 100 in producing filtered optical local oscillator signal LO′ or another phase shift that applies a fixed and predetermined phase relationship between the optical signals received at optical signal combiner 114.

Optical signal combiner 114 may generate a combined optical signal on optical path 116 by combining (adding) the phase-shifted optical local oscillator signal LO″ on optical path 110 with the filtered optical local oscillator signal LO′ on optical path 112. Optical path 116 may illuminate photomixer 118 using the combined optical signal. Photomixer 118 may generate electrical signal 122 based on the combined optical signal (e.g., where the photoactive area of photomixer 118 produces electrical current and/or voltage that forms electrical signal 122 responsive to photons of the combined optical signal on optical path 116). For example, photomixer 118 may perform a square law or heterodyning operation on the combined optical signal that generates electrical signal 122 as an electrical beat signal (e.g., at a beat frequency given by differences between the wavelengths, phases, and/or magnitudes of the phase-shifted optical local oscillator signal LO″ and the filtered optical local oscillator signal LO′ in the combined optical signal). If desired, optical signal combiner 114 and optical path 116 may be omitted and optical paths 110 and 112 may each illuminate photomixer 118.

Electrical path 120 may convey electrical signal 122 (e.g., a current or voltage signal waveform) from photomixer 118 to PID controller 124. PID controller 124 may generate control signal CTRL based on the phase and/or magnitude of electrical signal 122 over time. PID controller 124 may, for example, use control signal CTRL to adjust the biasing of laser 103 based on electrical signal 122 until a corresponding error signal reaches a minimum value (e.g., PID controller 124 may adjust the biasing of laser 103 until electrical signal 122 exhibits a voltage corresponding to a maximum amplitude or until phase difference matches a locking point set by a static phase shift).

At the same time, as shown by arrow 92, some of the wavelength λR of optical local oscillator signal LO on optical path 104 is reflected off optical resonator 100 and back towards the output of laser. This reflected optical signal is injected into laser 102 to self-injection lock laser 102 to wavelength λR. The wavelength of laser 102 (e.g., optical local oscillator signal LO) may need to equal a resonant wavelength of optical resonator 100 (e.g., wavelength λR) to become self-injection locked. However, in practice, optical resonator 100 exhibits a series of optical resonances at different wavelengths (e.g., as given by the optical comb of optical resonator 100). This may produce multiple possible stable operation wavelengths for laser 102 (e.g., one at each optical resonance in the optical comb).

For example, portion 128 of FIG. 4 plots the optical resonances of optical resonator 100 (through port transmission as a function of frequency) when configured to exhibit a nominal geometry. As shown by curve 130 in portion 128 of FIG. 4, optical resonator 100 may exhibit a set or comb of optical resonances 138 (illustrated by the minima of curve 130). Optical resonances 138 are separated in wavelength space by free spectral range 140. In practice, the wavelength of the optical local oscillator LO output by laser 102 needs to match one of the optical resonances 138 of curve 130 for laser 102 to be self-injection locked in a stable condition.

For example, signal 132 represents optical local oscillator signal LO at a wavelength in the vicinity of a given optical resonance 138 (e.g., at wavelength λR) prior to injection locking. At wavelength λR, transmission from input port 84 to through port 82 is minimal and thus optical signal reflection off optical loop 94 and back to input port 84 is maximal at wavelength λR. The reflected optical signal at wavelength λR is passed back to laser 102 and is injected into laser 102. This injection may cause laser 102 to self-injection lock the wavelength of its generated optical local oscillator signal LO onto wavelength λR, as shown by arrow 136. Signal 134 corresponds to the optical local oscillator signal LO after self-injection locking to wavelength λR.

As a result of self-injection locking, the optical intensity at drop port 86 may reach a maximum, which is detected and converted by photomixer 118 into an electrical voltage (e.g., electrical signal 120). Photomixer 118 and optical signal combiner 114 may, for example, effectively evaluate the amplitude and/or phase in the injection locking point of laser 102, which is either maximum in amplitude or the phase difference between drop port 86 and through port 82 is matched to meet the injection locking condition. The corresponding error voltage (e.g., characterized by electrical signal 122) is then fed back to input 103 of laser 102 (e.g., using PID controller 124 and control signal CTRL), which stabilizes the laser to remain at the self-injection locking point. This stability at the self-injection locking point may serve to reduce phase noise and jitter in the optical local oscillator signal LO generated by laser 102.

Any drift or error produced by temperature variation over time may produce phase and/or magnitude differences between the phase-shifted optical local oscillator LO″ on optical path 110 and the filtered optical local oscillator signal LO′ on optical path 112. These differences may produce corresponding changes in the electrical signal 122 on electrical path 120 (e.g., changes in phase and/or magnitude of electrical signal 122) that are detected by PID controller 124. PID controller 124 may then update the biasing of laser 102 (e.g., using control signal CTRL) to mitigate these drifts, helping to ensure that laser 102 remains self-injection locked to wavelength λR with minimal phase noise and jitter, even when device temperature changes over time. This may also allow bulky and power-intensive thermal cooling systems to be omitted from device 10 while maximizing the quality of the signal SIG output by signal generation circuitry 36.

The example of FIG. 4 is illustrative and non-limiting. If desired, optical path 112 may be coupled to add port 80 instead of drop port 86 of optical resonator 100. The electro-optical signal generation circuitry in FIG. 4 may be replaced with electrical signal generation circuitry if desired. In some implementations, the signal generation circuitry 36 in communications circuitry 20 (FIG. 1) may include two or more self-injection locking loops 142 integrated into an electro-optical phase locked loop (EOPLL).

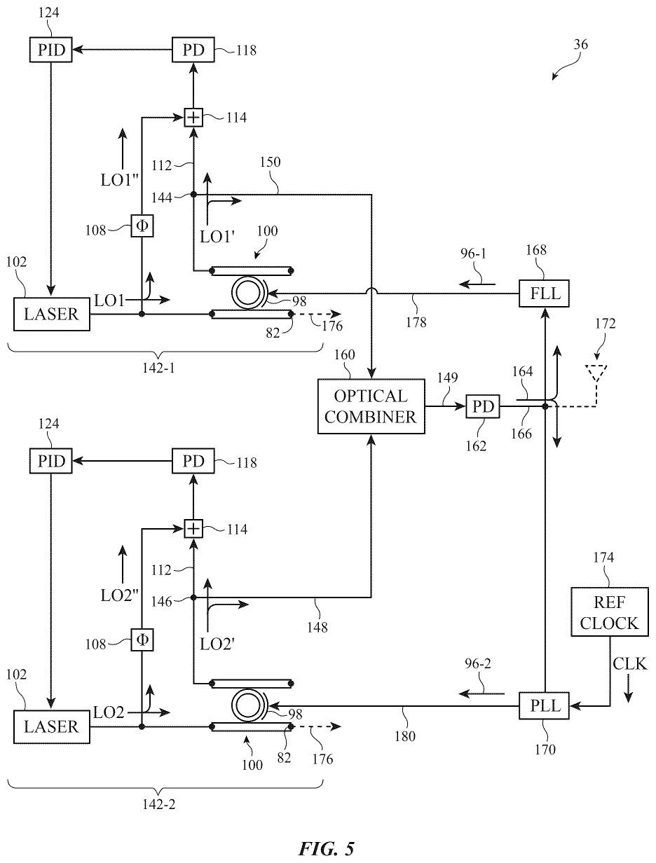

FIG. 5 is a circuit diagram showing how signal generation circuitry 36 may include a pair of self-injection locking loops 142 integrated into an EOPLL. As shown in FIG. 4, clocking circuitry 36 may include a first self-injection locking loop 142-1 and a second self-injection locking loop 142-2. If desired, self-injection locking loops 142-1 and 142-2 may be integrated into or disposed on different respective laser modules.

The laser 102 in self-injection locking loop 142-1 may output a first optical local oscillator signal LO1. The optical resonator 100 in self-injection locking loop 142-1 may filter optical local oscillator signal LO1 to produce filtered optical local oscillator signal LO1′. The optical phase shifter 108 in self-injection locking loop 142-1 may phase shift optical local oscillator signal LO1 to produce phase-shifted optical local oscillator signal LO1″.

The laser 102 in self-injection locking loop 142-2 may output a second optical local oscillator signal LO2. The optical resonator 100 in self-injection locking loop 142-2 may filter optical local oscillator signal LO2 to produce filtered optical local oscillator signal LO2′. The optical phase shifter 108 in self-injection locking loop 142-2 may phase shift optical local oscillator signal LO2 to produce phase-shifted optical local oscillator signal LO2″. The lasers 102 in self-injection locking loops 142-1 and 142-2 may generate optical local oscillator signals LO1 and LO2 at different respective frequencies that differ by a desired radio frequency. The radio frequency may be between around 600 MHz and around 10 THz, for example.

Signal generation circuitry 36 may also include an optical signal combiner such as optical combiner 160 (e.g., an optical coupler or adder), a photomixer 162 (e.g., a heterodyning electro-optical device such as a UTC PD, another type of programmable PD, etc.), an FLL 168, a PLL 170, and a reference clock 174. An optical path such as optical path 150 may couple a node 144 on the optical path 112 in self-injection locking loop 142-1 to a first input of optical combiner 160. An optical path such as optical path 148 may couple a node 146 on the optical path 112 in self-injection locking loop 142-2 to a second input of optical combiner 160. The output of optical combiner 160 may be optically coupled to a photoactive area of photomixer 162 over optical path 149. Optical paths 150, 148, and 149 may include optical fibers, optical waveguides, or other optical paths.

Photomixer 162 may have an electrical output coupled to electrical path 166 (e.g., a radio-frequency transmission line path). Electrical path 166 may couple the electrical output of photomixer 162 to the input of FLL 168 and to the input of PLL 170. FLL 168 may have an output coupled to the actuator 98 for the optical resonator 100 in self-injection locking loop 142-1 over electrical path 178. PLL 170 may have an output coupled to the actuator 98 for the optical resonator 100 in self-injection locking loop 142-2 over electrical path 180. PLL 170 may be clocked using a clock signal CLK from reference clock 174 (e.g., a system clock of device 10).

During operation, self-injection locking loop 142-1 may self-injection lock optical local oscillator signal LO1 to an optical resonance of its optical resonator 100 (e.g., as described above in connection with FIG. 4). Self-injection locking loop 142-2 may concurrently self-injection lock optical local oscillator signal LO2 to an optical resonance of its optical resonator 100 (e.g., as described above in connection with FIG. 4). Self-injection locking loop 142-1 may output its filtered optical local oscillator signal LO1′ onto optical path 150 via node 144 (e.g., an optical signal splitter or optical coupler). Optical path 150 may convey filtered optical local oscillator signal LO1′ to optical combiner 160. At the same time, self-injection locking loop 142-2 may output its filtered optical local oscillator signal LO2′ onto optical path 148 via node 144 (e.g., an optical signal splitter or optical coupler). Optical path 148 may convey filtered optical local oscillator signal LO2′ to optical combiner 160.

Optical combiner 160 may produce a combined optical signal on output path 149 by combining (adding) the filtered optical local oscillator signal LO2′ from optical path 148 with the filtered optical local oscillator signal LO1′ from optical path 150. Optical path 149 may illuminate photomixer 162 using the combined optical signal. Photomixer 162 may generate an electrical signal 164 on electrical path 166 based on the combined optical signal. Electrical signal 164 may be, for example, a radio-frequency signal (e.g., a beat signal) at a frequency given by the difference between the frequency of filtered optical local oscillator signal LO1′ and the frequency of filtered optical local oscillator signal LO2′ (e.g., around 600 MHz to around 10 THz).

Electrical path 166 may propagate electrical signal 164 to PLL 170. PLL 170 may include a divider, phase detector, subsampling mixer, loop filter, and/or other PLL circuitry involved in performing a PLL around self-injection locking loop 142-2. PLL 170 may generate a control signal 96-2 based on electrical signal 164 and clock signal CLK. Control signal 96-2 may be provided to the actuator 98 of the optical resonator 100 in self-injection locking loop 142-2 over electrical path 180. Control signal 96-2 may control actuator 98 to adjust the optical resonance of the optical resonator 100 in self-injection locking loop 142-2 (e.g., wavelength λR of FIG. 4), which adjusts the self-injection locking of the laser 102 in self-injection locking loop 142-2 to set or adjust the output frequency of signal generation circuitry 36 (e.g., as referenced to clock signal CLK).

Electrical path 166 may propagate electrical signal 164 to FLL 168 (e.g., outside of the PLL path formed by PLL 170). FLL 168 may include a counter, filter circuitry, and/or other FLL circuitry involved in performing an FLL around self-injection locking loop 142-1. FLL 168 may generate a control signal 96-1 based on electrical signal 164. Control signal 96-1 may be provided to the actuator 98 of the optical resonator 100 in self-injection locking loop 142-1 over electrical path 178. Control signal 96-1 may control actuator 98 to adjust the optical resonance of the optical resonator 100 in self-injection locking loop 142-1 (e.g., wavelength λR of FIG. 4), to set the frequency of the laser 102 in self-injection locking loop 142-1 close to or inside the locking range of PLL 170. This may configure self-injection locking loop 142-1 to produce an optical local oscillator LO1 that is locked to optical local oscillator LO2 (e.g., in a desired phase and/or frequency relationship) with minimal phase noise and jitter. This may also configure photomixer 162 to generate electrical signal 164 with minimal phase noise and jitter.

Optical local oscillator signal LO1, optical local oscillator signal LO2, and/or electrical signal 164 may form the signal that is output (generated) by signal generation circuitry 36 of FIG. 5 (e.g., signal SIG of FIG. 2). For example, signal generation circuitry 36 may have an output path 176 coupled to the through port 82 of the optical resonator 100 in self-injection locking loop 142-1 that outputs optical local oscillator LO1 for use in conveying data, may have an output path 176 coupled to the through port 82 of the optical resonator 100 in self-injection locking loop 142-2 that outputs optical local oscillator LO2 for use in conveying data, and/or may have an output port coupled to electrical path 166 that outputs electrical signal 164 for use in conveying data.

As one example, an antenna resonating element such as antenna element 172 (e.g., one or more antenna arms, slot antenna elements, patch antenna elements, dipole antenna arms, monopole antenna arms, inverted-F antenna arms, etc.) may be coupled to the electrical output of photomixer 162 and/or electrical path 166. Antenna element 172 may wirelessly transmit (radiate) electrical signals 164 as wireless signals 32 of FIG. 1. Additionally, or alternatively, antenna element 172 may wireless receive electrical signals as wireless signals 34 of FIG. 1. The received wireless signals may be passed to a receiver (not shown) coupled to electrical path 166 or to a receiver (not shown) coupled to an electrical terminal of photomixer 162. Antenna element 172 may sometimes also be referred to herein as antenna 172. In some implementations, photomixer 162 and antenna element 172 are referred to collectively as an antenna (e.g., antenna 30 of FIG. 1).

Antenna element 172 may be linearly polarized or may include orthogonal linearly polarized antenna elements. If desired, antenna element 172 may be one antenna element in a phased antenna array of antennas 30 in device 10 (FIG. 1). The phased antenna array may form a corresponding beam of wireless signals oriented in a beam pointing direction. If desired, the phase of one or both filtered optical local oscillator signals provided to optical combiner 160 may be phase shifted using corresponding optical phase shifters (not shown) (e.g., on optical path 150 or optical path 148) to adjust or set the beam pointing direction. If desired, wireless data may be modulated onto filtered optical local oscillator signal LO1′ or filtered optical local oscillator signal LO2′ by an electro-optical modulator such as a Mach Zehnder modulator (MZM) (not shown) on optical path 150 or optical path 148. The electro-optical modulator may, for example, include a set of electrodes. One or more of the electrodes may be provided with a bias or reference voltage. One or more of the electrodes may receive an electrical signal (e.g., from an electrical transmit chain, an analog-to-digital converter, a different signal generator, etc.) that conveys the wireless data to be transmitted. The electrical signals may cause the electrode(s) to adjust relative optical path lengths between different branches of the electro-optical modulator to effectively modulate the wireless data onto the corresponding filtered optical local oscillator signal. These data modulations are maintained in the electrical signal 164 output by photodiode 162 and may be wirelessly transmitted by antenna element 172.

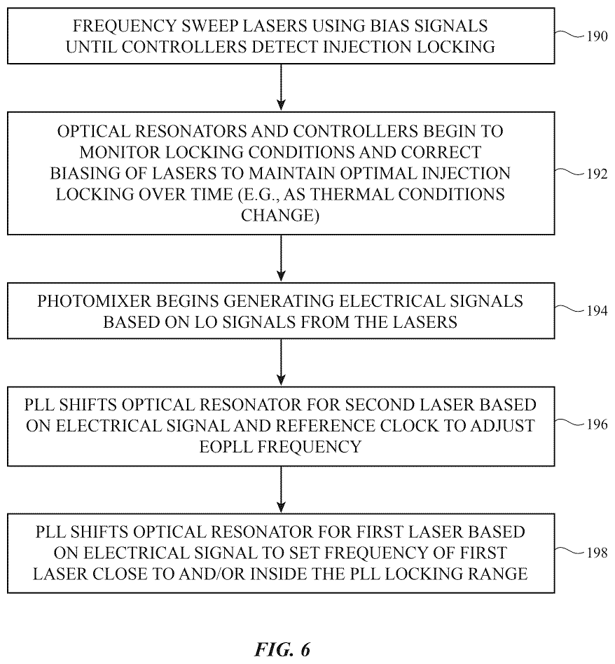

FIG. 6 is a flow chart of illustrative operations that may be performed by the EOPLL of FIG. 5. At operation 190, the PID controllers 124 in self-injection locking loops 142-1 and 142-2 may frequency (wavelength) sweep the lasers 102 in self-injection locking loops 142-1 and 142-2 (e.g., using respective control signals that adjust biasing of the lasers) until PID controllers 124 detect that the lasers have been injection-locked to the corresponding optical resonators 100.

At operation 192, the optical resonators 100 and PID controllers 124 in self-injection locking loops 142-1 and 142-2 may begin to monitor the self-injection locking of lasers 102. PID controllers 124 may update the biasing of lasers 102 over time based on the electrical signals output by photomixers 118 to maintain stable self-injection locking of lasers 102 over time (e.g., as thermal conditions such as temperature change without needing to separately measure temperature). Self-injection locking loops 142-1 and 142-2 may continue to perform operation 192 concurrent with the remaining operations of FIG. 6.

At operation 194, photomixer 162 may begin to generate electrical signal 164 based on the filtered optical local oscillator signals LO1′ and LO2′ output by the self-injection locking loops 142-1 and 142-2. Photomixer 162 may continue to perform operation 194 concurrent with the remaining operations of FIG. 6.

At operation 196, PLL 170 may shift the optical resonance of the optical resonator 100 in self-injection locking loop 142-2 based on electrical signal 164 and clock signal CLK from reference clock 174. This may, for example, serve to adjust the frequency of the signal output by signal generation circuitry 36.

At operation 198, FLL 168 may shift the optical resonance of the optical resonator 100 in self-injection locking loop 142-1 based on electrical signal 164. This may, for example, serve to set and/or adjust the frequency of the laser in self-injection locking loop 142-1 to a frequency close to or inside the locking range of PLL 170.

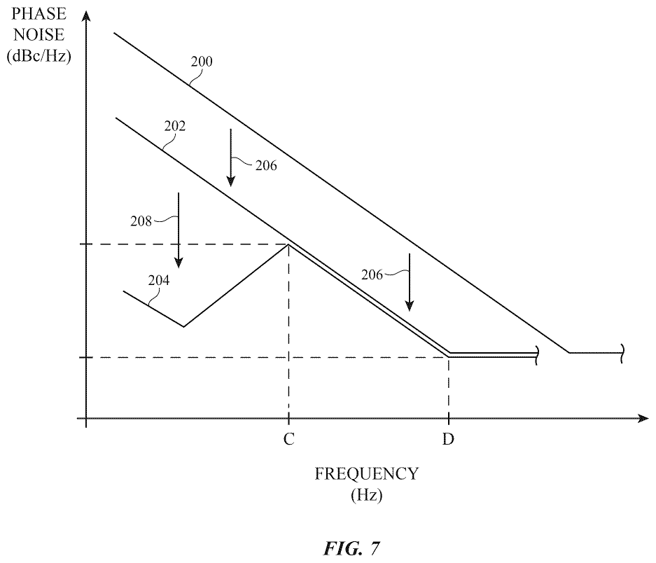

FIG. 7 is a plot showing how signal generation circuitry 36 may minimize phase noise in the signal SIG (FIG. 2) output by the signal generation circuitry. The vertical axis of FIG. 7 plots phase noise (e.g., in dBc/Hz) and the horizontal axis of FIG. 7 plots frequency (e.g., in Hz). As shown in FIG. 7, curve 200 plots the phase noise of the signal SIG output by signal generation circuitry 36 without self-injection locking. As shown by curve 200, phase noise may be relatively high across frequencies when self-injection locking is not performed (e.g., phase noise may be too high to support accurate data communications).

Curve 202 plots the phase noise of signal SIG when the self-injection locking loop(s) 142 in signal generation circuitry 36 have been injection locked to the corresponding resonator(s). As shown by arrows 206, self-injection locking may reduce phase noise in signal SIG at frequencies below frequency D. Frequency D may, for example, be given by the injection locking bandwidth of the self-injection locking loop.

Curve 204 plots the phase noise of signal SIG when the self-injection locking loop(s) 142 have been phase locked after becoming self-injection locked (e.g., by PLL 170 of FIG. 5). As by arrow 208, the PLL may further reduce phase noise at frequencies below frequency C. Frequency C may, for example, be given by the bandwidth of the PLL. The example of FIG. 7 is illustrative and non-limiting. Curves 200-204 may have other shapes in practice.

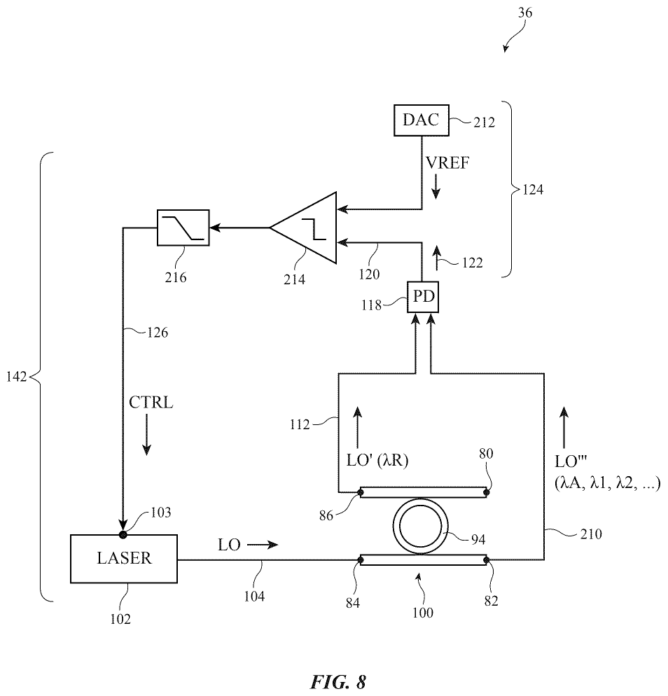

The example of FIGS. 4 and 5 in which optical self-injection locking loop 142 includes an optical signal combiner 114 coupled to node 106 via optical path 110 is illustrative and non-limiting. FIG. 8 illustrates another example in which optical signal combiner 114 of FIG. 4 has been omitted. As shown in FIG. 8, through port 82 of optical resonator 100 may be optically coupled to photomixer 118 over optical path 210.

Optical path 112 may illuminate photomixer 118 using filtered optical local oscillator signal LO′. Optical resonator 100 may output an additional filtered optical local oscillator signal LO′″ onto optical path 210 via through port 82. Filtered optical local oscillator signal LO′″ may include the frequencies of optical local oscillator signal LO that are not filtered out by optical loop 94 and passed onto drop port 86 (e.g., wavelengths λA from add port 80, λ1, λ2, λ3, etc.). Optical path 210 may illuminate photomixer 118 using filtered optical local oscillator signal LO′″. Photomixer 118 may generate electrical signal 122 based on filtered optical local oscillator signals LO′ and LO′″.

As shown in FIG. 8, PID controller 124 may include comparator 214, digital-to-analog converter (DAC) 212, and filter 216. The output of DAC 212 may be coupled to a first input of comparator 214. The second input of comparator 214 may be coupled to electrical path 214. DAC 212 may provide reference voltage VREF to the first input of comparator 214. Comparator 214 may compare reference voltage VREF to electrical signal 122 and may output a corresponding comparison signal to filter 216. The comparison signal may, for example, have a first magnitude when the magnitude of electrical signal 122 exceeds the magnitude of reference voltage VREF and may have a second magnitude when the magnitude of reference voltage VREF exceeds the magnitude of electrical signal 122. Filter 216 may filter the comparison value to produce the control signal CTRL provided to input 103 of laser 102.

The example of FIG. 8 is illustrative and non-limiting. If desired, an optical phase shifter may be disposed on optical path 210. In general, PID controller 124 may have other components. The magnitude of reference voltage VREF may be set during a calibration operation. In electrical implementations, optical resonator 100 may be replaced with an electrical resonator, laser 102 may be replaced with an electrical oscillator, optical paths 104, 112, and 210 may be replaced with electrical paths, and photomixer 118 may be replaced with a square law device (e.g., square law device 58 of FIG. 2).

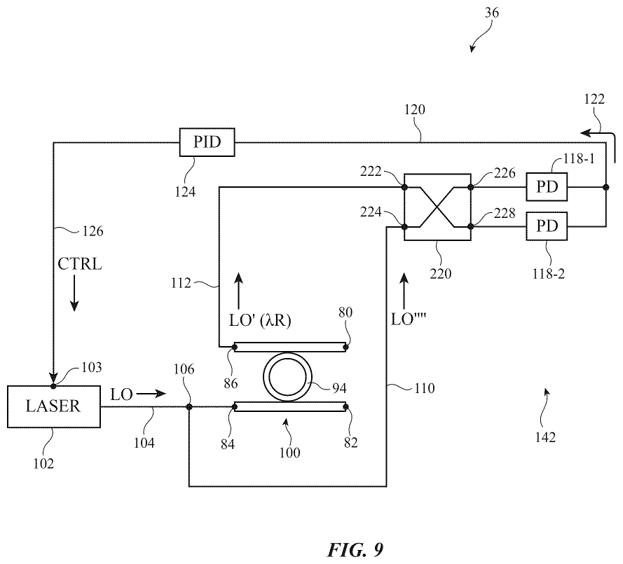

If desired, signal generation circuitry 36 may include a hybrid coupler. FIG. 9 is a circuit diagram showing example of an electro-optical implementation in which signal generation circuitry 36 includes a hybrid coupler. As shown in FIG. 9, signal generation circuitry 36 may include a signal coupler such as hybrid coupler 220 (e.g., a hybrid electrical coupler). Hybrid coupler 220 may be, for example, a 90-degree hybrid coupler. Hybrid coupler 220 may have a first input port (terminal) 222, a second input port 224, a first output port 226 coupled to input port 224, and a second output port 228 coupled to input port 222.

Signal generation circuitry 36 may include a balanced detector that includes a pair of photomixers 118 such as photomixer 118-1 and photomixer 118-2. The photoactive area of photomixer 118-1 may be optically coupled to output port 226. The photoactive area of photomixer 118-2 may be optically coupled to output port 228. Photomixers 118-1 and 118-2 may have electrical outputs coupled to electrical path 120.

Optical path 110 may couple node 106 on optical path 104 to input port 224 of hybrid coupler 220. Optical path 112 may couple drop port 86 of optical resonator 100 to input port 222 of hybrid coupler 220. Optical resonator 100 may provide filtered optical local oscillator signal LO′ to input port 224 over optical path 112. Optical path 110 may pass optical local oscillator signal LO to input terminal 224. If desired, an optical phase shifter may be disposed on optical path 110 to provide phase-shifted optical local oscillator signal LO″ (FIG. 4) to input terminal 224.

Hybrid coupler 220 may pass the filtered optical local oscillator signal LO′ from input terminal 222 to photomixer 118-2 through output port 228. Hybrid coupler 220 may pass the optical local oscillator signal LO (or phase-shifted optical local oscillator signal LO″) from input terminal 224 to photomixer 118-1 through output port 226 with a fixed phase relationship relative to the filtered optical local oscillator signal LO′ at output port 228. The optical signal provided to photomixer 118-1 may, for example, be 90 degrees out of phase with respect to the optical signal provided to photomixer 118-2 in implementations where hybrid coupler 220 is a 90-degree hybrid coupler.

Photomixer 118-1 may convert the optical signal received from output port 226 into an electrical signal on electrical path 120. Photomixer 118-2 may convert the optical signal received from output port 228 into an electrical signal on electrical path 120. The electrical signals output by photomixers 118-1 and 118-2 may collectively form the electrical signal 122 passed to PID controller 124 (e.g., an error signal). PID controller 124 may adjust control signal CTRL based on phase differences between the electrical signals produced by photomixers 118-1 and 118-2.

The example of FIG. 9 is illustrative and non-limiting. In electrical implementations, optical resonator 100 may be replaced with an electrical resonator, laser 102 may be replaced with an electrical oscillator, optical paths 104, 112, and 110 may be replaced with electrical paths, hybrid coupler 220 may be an electrical hybrid coupler, and photomixers 118-1 and 118-2 may be replaced with any desired balanced square law device (e.g., square law device 58 of FIG. 2).

As used herein, the term “concurrent” means at least partially overlapping in time. In other words, first and second events are referred to herein as being “concurrent” with each other if at least some of the first event occurs at the same time as at least some of the second event (e.g., if at least some of the first event occurs during, while, or when at least some of the second event occurs). First and second events can be concurrent if the first and second events are simultaneous (e.g., if the entire duration of the first event overlaps the entire duration of the second event in time) but can also be concurrent if the first and second events are non-simultaneous (e.g., if the first event starts before or after the start of the second event, if the first event ends before or after the end of the second event, or if the first and second events are partially non-overlapping in time). As used herein, the term “while” is synonymous with “concurrent.”

Devices 10 may gather and/or use personally identifiable information. It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

The foregoing is merely illustrative and various modifications can be made to the described embodiments. The foregoing embodiments may be implemented individually or in any combination.

What is claimed is:

1. Communication circuitry comprising:
an oscillator configured to generate a signal;
a resonator having an input coupled to the oscillator over a signal path, the resonator being configured to
output a filtered signal based on the signal, and
self-injection lock the oscillator by reflecting a portion of the signal back to the oscillator over the signal path;
a square law device having an input communicatively coupled to an output of the resonator and configured to generate an electrical signal based on the filtered signal; and
a controller configured to adjust the oscillator based on the electrical signal.

2. The communication circuitry of claim 1, further comprising:
a signal combiner having a first input coupled to the output of the resonator, a second input communicatively coupled to a node on the signal path between the resonator and the oscillator, and an output coupled to the input of the square law device.

3. The communication circuitry of claim 2, further comprising:
a phase shifter coupled between the node and the second input of the signal combiner, the phase shifter being configured to generate a phase-shifted signal based on the signal, and the square law device being configured to generate the electrical signal based on the phase-shifted signal.

4. The communication circuitry of claim 3, wherein the signal comprises a radio-frequency signal and the resonator comprises a radio-frequency resonator.

5. The communication circuitry of claim 3, wherein the oscillator comprises a laser, the signal comprises an optical signal, the resonator comprises an optical resonator, the phase shifter comprises an optical phase shifter, and the square law device comprises a photomixer.

6. The communication circuitry of claim 1, wherein the resonator has a resonant frequency, the filtered signal is at the resonant frequency, and the portion of the signal reflected back to the oscillator is at the resonant frequency.

7. The communication circuitry of claim 1, wherein oscillator includes a laser, the resonator includes an optical ring, a drop port, an input port, a through port, and an add port, the input port is coupled to the signal path, and the drop port is communicatively coupled to the input of the square law device.

8. The communication circuitry of claim 7, further comprising:
an optical combiner having an output coupled to the input of the square law device; and
a first optical path that couples the drop port to a first input of the optical combiner.

9. The communication circuitry of claim 8, further comprising:
a second optical path that couples the node on the signal path to a second input of the optical combiner; and
an optical phase shifter disposed on the second optical path.

10. The communication circuitry of claim 8, wherein the optical ring has a resonant wavelength, the optical ring is configured to pass the resonant wavelength of the signal from the input port onto the drop port, and the portion of the signal reflected back to the oscillator is at the resonant wavelength.

11. The communication circuitry of claim 7, further comprising:
a first optical path that couples the drop port to the square law device; and
a second optical path that couples the through port to the square law device.

12. The communication circuitry of claim 7, wherein the square law device comprises a photodiode.

13. The communication circuitry of claim 1, wherein the controller comprises:
a comparator having a first input coupled to an output of the square law device;
a digital-to-analog converter (DAC) configured to supply a reference voltage to a second input of the comparator; and
a filter coupled between an output of the comparator and a control input of the oscillator.

14. The communication circuitry of claim 1, further comprising:
a hybrid coupler having a first input port coupled to the output of the resonator, a second input port coupled to the node on the signal path, a first output port coupled to the input of the square law device, and a second output port; and
an additional square law device having an input coupled to the second output port of the hybrid coupler and configured to contribute to the electrical signal based on the signal generated by the oscillator.

15. Communication circuitry comprising:
a first self-injection locking loop configured to generate a first optical signal using a first laser and a first optical resonator;
a second self-injection locking loop configured to generate a second optical signal using a second laser and a second optical resonator;
a photomixer configured to generate an electrical signal based on the first optical signal and the second optical signal; and
a phase locked loop configured to adjust an optical resonance of the second optical resonator based on the electrical signal and a reference clock.

16. The communication circuitry of claim 15, further comprising:
a frequency locked loop configured to adjust an optical resonance of the first optical resonator based on the electrical signal.

17. The communication circuitry of claim 15, further comprising:
an optical combiner having a first input coupled to a drop port of the first optical resonator, having a second input coupled to a drop port of the second optical resonator, and having an output optically coupled to the photomixer;
a first controller in the first self-injection locked loop, the first controller being configured to adjust a bias of the first laser based on a filtered version of the first optical signal and a phase-shifted version of the first optical signal; and
a second controller in the second self-injection locked loop, the second controller being configured to adjust a bias of the second laser based on a filtered version of the second optical signal and a phase-shifted version of the second optical signal.

18. The communication circuitry of claim 15, further comprising:
an antenna element coupled to the electrical path and configured to transmit wireless signals corresponding to the electrical signal.

19. An electronic device comprising:
a laser configured to emit an optical signal;
an optical resonator having a first port coupled to the laser over a first optical path and configured to self-injection lock the laser to a resonant wavelength of the optical resonator using a reflected portion of the optical signal;
an optical combiner having a first input coupled to a node on the first optical path over a second optical path and having a second input coupled to a second port of the optical resonator;
an optical phase shifter disposed on the second optical path;
a photomixer coupled to an output of the optical combiner over a third optical path; and
circuitry coupled to an output of the photomixer and configured to adjust a bias of the laser.

20. The electronic device of claim 19, wherein the reflected portion of the optical signal is at the resonant wavelength, the optical resonator is configured to output a filtered signal on the second port at the resonant wavelength, the phase shifter is configured to generate a phase-shifted optical signal based on the optical signal, and the photomixer is configured to provide an electrical signal to the circuitry based on the phase-shifted signal and the filtered signal.
